(19) United States
(12) Patent Application Publication
(10) Pub. No.: US 2003/0177090 A1
(43) Pub. Date: Sep. 18, 2003

(54) System and method for automatic bill payment

(76) Inventor: Guy Eden, Tustin, CA (US)

Correspondence Address: David C. Ripma, Patent Counsel, Sharp Laboratories of America, Inc., 5750 NW Pacific Rim Boulevard, Camas, WA, 98607, US

(21) Appl. No.: 10/096,771

(22) Filed: Mar. 12, 2002

(51) Int. Cl. G06F 17/60

(52) U.S. Cl. 705/40

(57) ABSTRACT

A system and method are provided for automatically paying bills. The method comprises: scanning a received bill; accessing a standard template library (STL); matching the received bill to a bill template from the STL; using the bill template to identify data areas; reading parameters from data areas on the received bill; and, transmitting a payment in response to the parameters. Some common parameters to be read form the data areas of the received bill include the account number, the service provider address, the due date, and the amount owed. Some aspects of the method further comprise establishing an accessible on-line checking account. Then, transmitting a payment includes electronically debiting the checking account and electronically submitting the amount due to the service provider drawn on the checking account. Alternately, a check can be generated for the service provider drawn on the checking account. If a check is generated, it is printed with populated fields such as the payee's name, the amount, the account number, and a signature. Other aspects of the method further comprise: accessing an on-line server master template library; and, downloading templates into a local database standard template library. The on-line server master template library includes templates in a first plurality of languages. Therefore, downloading templates into a local database standard template library includes selecting a language.

### BACKGROUND OF THE INVENTION

1. Field of the Invention

This invention generally relates to accounting software and, more particularly, to a system and method for automatically paying bills in response to scanning a received bill.

2. Description of the Related Art

Hundreds of millions of people spend hours every month on the grueling task of paying their bills. The task of paying bills is performed in many variations. The most common of which is to receive the bill, procrastinate payment till the last moment, and write a check. Writing a check includes filling in the payee's name, the amount, the due date, and endorsing it. Enclosing the check in the envelope provided by the vendor, affixing a stamp, and finding a mailbox to drop it into completes the task. Another variation is to boot up a computer and use a financial or bookkeeping software application to make a record of payments in the user's checking account. Some systems permit a user to electronically make the payment to the service provider or vendor who has sent the bill.

One problem is the time spent in the process of paying bills. A couple more problems are the money spent on stamps and the need to file the bill for the records. Even if an accounting software application is used, the user must enter the bill, debit the account, and enable the payment.

It would be advantageous if the bill payment process could be structured on the day that a bill is received.

It would likewise be advantageous if the debtor receiving the bill could be relieved of the anxiety of waiting until the due date before paying the bill, without the disadvantage of paying the bill too early.

### SUMMARY OF THE INVENTION

The present invention describes a process of scanning a received bill and automatically paying the scanned bill. No ink is needed in the process, no stamps need to be purchased, envelopes are saved, and so is the trip to the mailbox. An electronic archive is maintained as a record.

Accordingly, a method is provided for automatically paying bills. The method comprises: scanning a received bill; accessing a standard template library (STL); matching the received bill to a bill template from the STL; using the bill template to identify data areas; reading parameters from data areas on the received bill; and, transmitting a payment in response to the parameters. Some common parameters to be read form the data areas of the received bill include the account number, the service provider address, the due date, and the amount owed.

Some aspects of the method further comprise establishing an accessible on-line checking account. Then, transmitting a payment includes electronically debiting the checking account and electronically submitting the amount due to the service provider drawn on the checking account. Alternately, a check can be generated for the service provider drawn on the checking account. If a check is generated, it is printed with populated fields such as the payee's name, the amount, the account number, and a signature.

Other aspects of the method further comprise: accessing an on-line server master template library; and, downloading templates into a local database standard template library. The on-line server master template library includes templates in a first plurality of languages. Therefore, downloading templates into a local database standard template library includes selecting a language.

Additional details of the above-described method and a system for automatically paying bills are presented below.

### BRIEF DESCRIPTION OF THE DRAWINGS

FIG. 1 is a schematic block diagram of the present invention system for automatically paying bills.

FIG. 2 is a diagram illustrating an exemplary bill.

FIG. 3 is a schematic block diagram illustrating an alternate aspect of the system for automatically paying bills.

FIG. 4 is a flowchart illustrating the present invention method for automatically paying bills.

FIG. 5 is a flowchart illustrating an alternate aspect of the method of FIG. 4 for automatically paying bills.

### DETAILED DESCRIPTION OF THE PREFERRED EMBODIMENTS

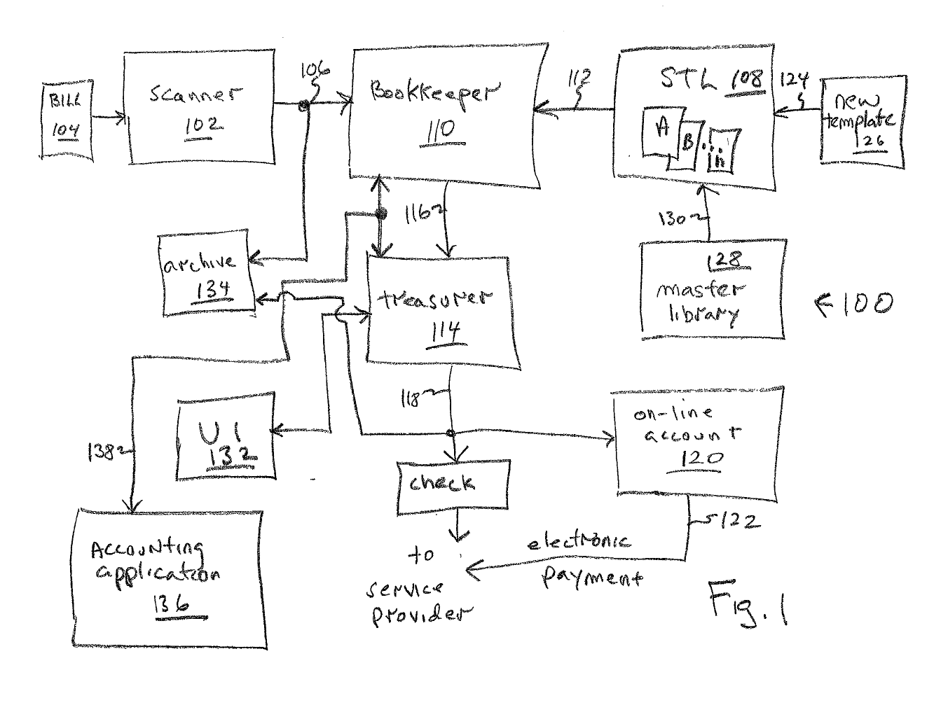

FIG. 1 is a schematic block diagram of the present invention system for automatically paying bills. The system 100 comprises a scanner 102 having an input to accept a received bill 104 and an output on line 106 to supply a scanned readout of the bill. A standard template library (STL) 108 includes a plurality of bill templates. Shown are templates A through n, however, the STL 108 is not limited to any particular number of templates.

A bookkeeper 110 has a port connected to the scanner output on line 106 to received scanned bills and a port connected to the standard template library output on line 112 to receive bill templates. The bookkeeper 110 matches the received bill to a bill template from the STL 110. The bookkeeper uses the bill template to identify data areas and, then, reads parameters from data areas on the received bill. Typically, the bookkeeper 110 includes an optical character recognition (OCR) algorithm to read information in the identified data areas.

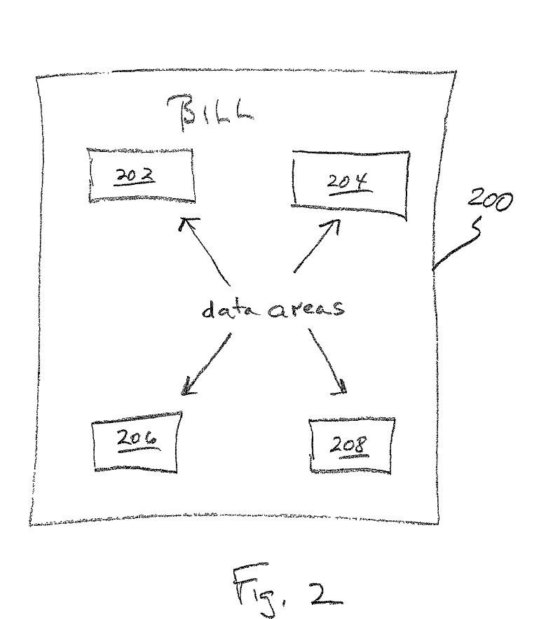

FIG. 2 is a diagram illustrating an exemplary bill 200. The bill 200 has a plurality of data areas 202, 204, 206, and 208. Once the proper template is identified, the data areas on the bill are located from the template, and the bookkeeper reads parameters from the identified data areas. Not all bills, or their corresponding bill templates need necessarily include the same parameter types.

Returning to FIG. 1, a treasurer 114 has an input on line 116 to receive parameters from the bookkeeper 110 and a output on line 118 to supply a payment in response to the parameters. The bookkeeper reads parameters from data areas on the received bill such as the account number, the service provider address, the due date, and the amount owed. These are just examples of likely data area parameters. The present invention is not limited to any particular number or type of parameter.

Some aspects of the system 100 further comprise an accessible on-line checking account 120. In some aspects, communication between the treasurer and the on-line account are enabled through Internet communications. However, the present invention system is not limited to any particular transmission medium. The treasurer 114 communicates with the on-line checking account to electronically debit the checking account in response electronically submitting the amount due to the service provider drawn on the checking account, which is represented by line 122. Alternately, the account 120 is debited in response to the treasurer 114 generating a check to the service provider drawn on the checking account. The treasurer 114 prints a check with populated fields such as the payee's name, the amount, the account number, and a signature.

In some aspects of the system 100, the STL 108 has an input on line 124 to accept a new template 126. The STL 108 identifies data areas on the new template 126 and adds the new template to the standard template library 108. In other aspects, the system 100 comprises an online server master template library 128. The standard template library 108 has an input on line 130 to accept downloaded templates from the master template library. Again, communications between the STL 108 and the master library 128 can be enabled with Internet communications. However, the present invention system is not limited to any particular transmission medium. The standard template library 108 accesses the on-line server master template library 128 in response to either automatic periodic updates or user-initiated requests.

In some aspects, the master template library 128 includes templates in a first plurality of languages and the standard template library 108 downloads templates in response to selecting a language. For example, the STL 108 can request an English version template for an AT&T bill for a user located in the United States.

Some aspects of the system 100 further comprise a user interface (UI) 132 for selecting an operating mode, either automatic or semi-automatic. In response to selecting the semi-automatic operating mode, the user interface 132 supplies user prompts such as the payment date and payment amount. The treasurer 114 pays the bill in response to the selected user prompts when the semiautomatic mode is selected. However, the treasurer 114 automatically pays the bill in response to the automatic mode being selected. In some aspects, an archive 134 has an input connected to the scanner output 106 for storing received bills, and to the treasurer 114 for storing transmitted payments.

Some aspects of the present invention system further comprise an accounting application 136 having a port on line 138 connected to the bookkeeper 110 and the treasurer 114. One well-known example of an accounting application is Quicken. The accounting application 136 performs actions such as making a record of the received bill in the accounting application, ordering the treasurer 114 to automatically transmit a payment, ordering the treasurer 114 to access an on-line account, and making a record of the transmitted payment in the accounting application. Alternately stated, the present invention system 100 is able to share many of the above-described tasks with the accounting application 136.

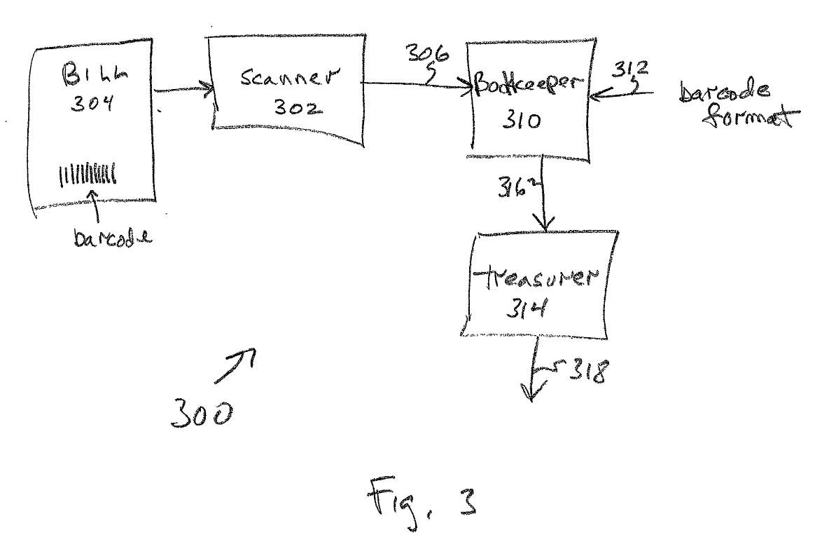

FIG. 3 is a schematic block diagram illustrating an alternate aspect of the system for automatically paying bills. The system 300 of FIG. 3 comprises a scanner 302 having an input to accept a received bill 304 with barcode information. The scanner 302 has an output on line 306 to supply a scanned readout of the bill barcode. A bookkeeper 310 has a port connected to the scanner output on line 306 to received scanned bills and a line on 312 to receive the barcode format. The barcode format can be stored in a memory, for example. The bookkeeper 310 reads parameters from the barcode on the received bill. A treasurer 314 has an input on line 316 to receive parameters from the bookkeeper 310 and an output on line 318 to supply a payment in response to the parameters. The system 300 of FIG. 3 shares many similarities with the system of FIG. 1, and a reiteration of those features is not repeated herein in the interest of brevity.

### Functional Description

The present invention begins with a user scanning their bill. In some aspects, the user receives a bill in a scanned format, such as when the bill is delivered via email. Once the bill is scanned, the system processes the scanned image. It should be understood that most of the elements of the above-described present invention system are enabled with software. The scanned image is analyzed, and a payment is made on behalf of the payer.

The software uses a template library that includes a sample of all known bills. The library is typically stored on the user's computer. Every scanned bill is compared with the templates in the library. Once a match is found, the software is able to read parameters such as the account number, the service provider's address, the date due, and the amount to pay.

An image pattern recognition algorithm can be used to find a match to the scanned image in the template library. Computer Vision and Image Understanding is a well-known discipline in the computer science society, and there are many such software applications in the market to solve the problem of pattern recognition and image understanding.

The template library is updated by connecting to an online server. The local database is updated and synchronized, looking up data on the server. The update can be done periodically, for example, once every ten days, or initiated by the user.

The user is also supplied with ways to customize templates. In case the user has a bill to which a match is not found in the standard template library, a new template can be created. The new template will be a match for this bill. Any such bills received in the future can be analyzed with the new template. The next time that this bill is scanned, the software will search for a match in the STL and in the customized template list, and a match is guaranteed.

The user has payment options. The default option debits the checking account and sends the payment to the payee. The payment can be sent electronically if possible, and if not, by check. This is similar to the concept of paying bills online-with an electronic bill payment system. Another possibility is to print the check. The printed check can include all the data need to make payment—the amount, the date, the account numbers, and a signature. All the payer needs to do is to enclose the check and send it.

Data of all payments is persisted in a local database, for the sake of record maintenance. The payer no longer needs to save paper records. The archive also provides an electronic search means.

The process of bill payment can be done in two modes, either fully automatic or semi-automatic. In the fully automatic mode, the payer launches the software, scans a bill, and the payment is transmitted by the software, in the fashion described above. In the semi-automatic mode, the payer is prompted with a confirmation dialog. When this mode is set, the payer is able to select a different amount to pay. For example, a payer may opt to pay a partial balance on their credit card bill. The default option is to pay the full amount due. The payer can also change the date for which the payment is scheduled. The mode is configurable by the software, and the user can choose whichever mode in which they are comfortable.

A summary of the automatic bill paying process is presented below:

Scan bill->Image file created;

Software automatically launched, fed with the image;

Software iterates through STL, attempts to find a match;

Match not found? Iterate through customized template library and find a match;

Use OCR zones specified for the template, to extract data from the form;

Extract all required fields (account number, Payment date, amount to pay, etc.);

Remit payment, or print check, depending on the options; and,

Save scanned document in archive for the records.

Template libraries can be localized. For example, for Japanese customers in Japan, a Japanese STL would be provided with templates consisting of Japanese characters and numbers. Likewise, a Malaysian STL would be established for the Malaysian customers. Communication with on-line entities, such as a master library or on-line bank can be encrypted for security, using a common encryption protocol (e.g., SSL, PGP, IPSec or S/MIME)

It is also possible to interface other accounting software packages, inventory bookkeeping software, or accounting department's software, for corporate usage. The process of extracting data from the scanned bill (i.e., payment date, amount to pay, etc.) is done using OCR zone technology. OCR zone technology extracts text from specific zones for automatic indexing of forms. The process of customizing a template defines OCR zones for the required fields. In another aspect, the bill service providers would print a bar code which will have all the data encoded. In this case, the task of searching through the STL is eliminated. This requires the cooperation of the service providers, but it is not a compelling prerequisite. If the bar code is not present, the usage of the STL and the user-customized library will be incorporated.

There are several ways for the software to interface with payment vendors. They all involve electronic bill payment through a wide array of Internet sites such as banks, brokerages, credit unions, and portals. Payment can also be made using personal finance software, such as Quicken. Alternately, bill payment can be enabled by phone, which gives the speed, control and accuracy needed to make paying bills simple and fast, utilizing touch-tone keying.

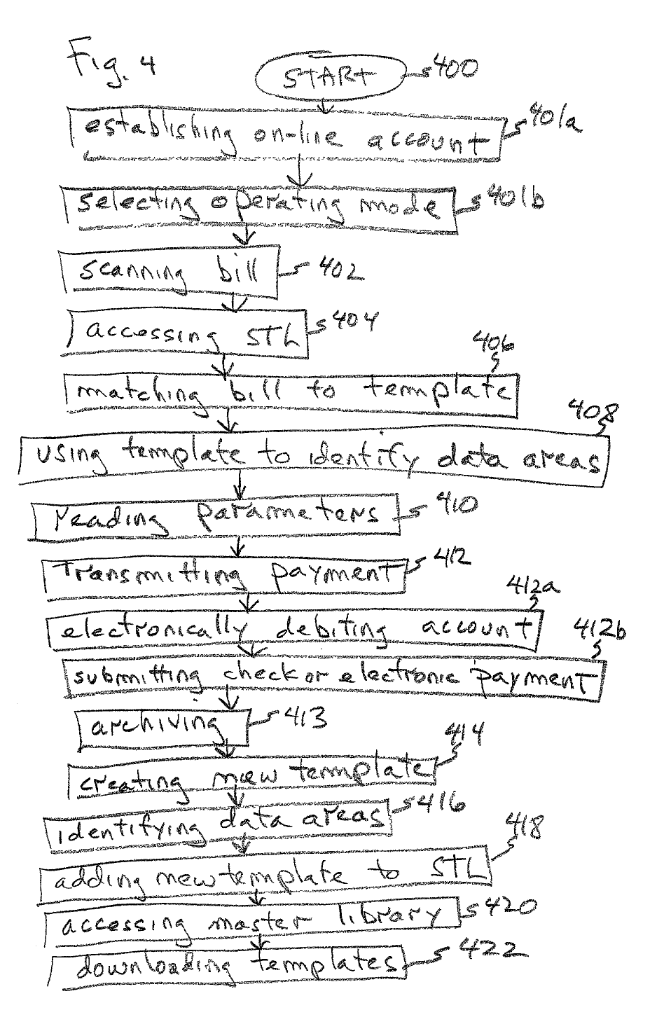

FIG. 4 is a flowchart illustrating the present invention method for automatically paying bills. Although this method is depicted as a sequence of numbered steps for clarity, no order should be inferred from the numbering unless explicitly stated. It should be understood that some of these steps may be skipped, performed in parallel, or performed without the requirement of maintaining a strict order of sequence. The methods start at Step 400. Step 402 scans a received bill. Step 404 accesses a standard template library (STL). Step 406 matches the received bill to a bill template from the STL. Step 408 uses the bill template to identify data areas. Step 410 reads parameters from data areas on the received bill. Reading parameters from data areas on the received bill includes reading parameters such as account number, the service provider address, the due date, and the amount owed. In some aspects of the method, reading parameters from data areas on the received bill includes using an optical character recognition (OCR) algorithm to read information in the identified data areas. Step 412 transmits a payment in response to the parameters.

Some aspects of the method comprise a further step. Step 401a optionally establishes an accessible on-line checking account. Then, transmitting a payment in Step 412 includes substeps. Step 412a electronically debits the checking account. Step 412b either electronically submits the amount due to the service provider drawn on the checking account, or generates a check to the service provider drawn on the checking account. Transmitting a payment includes printing a check with populated fields such as payee's name, amount, account number, and signature.

Some aspects include further steps. Step 414 creates a new template. Step 416 identifies data areas on the new template. Step 418 adds the new template to the standard template library. In other aspects, Step 420 accesses an on-line server master template library in response to automatic periodic updating or user-initiated requests. Step 422 downloads templates into a local database standard template library.

In some aspects, accessing an on-line server master template library in Step 420 includes accessing a master template library with templates in a first plurality of languages. Then, downloading templates into a local database standard template library in Step 422 includes selecting a language.

Some aspects of the method comprise a further step. Step 401b selects either an automatic or semi-automatic an operating mode. In response to selecting the semi-automatic operating mode, Step 412 supplies user prompts selected from the group including payment date and payment amount, and pays the bill in response to the selected user prompts. In response to selecting the automatic mode, Step 412 automatically pays the bill. In some aspects, Step 413 archives the received bill and transmitted payments.

In some aspects of the method, Step 401c (not shown) accesses an accounting application. Then, Step 412 may include automatically transmitting a payment or accessing an on-line account in response to the accounting application. Step 413 may include making a record of the received bill in the accounting application or making a record of the transmitted payment in the accounting application, in response to accessing the accounting application.

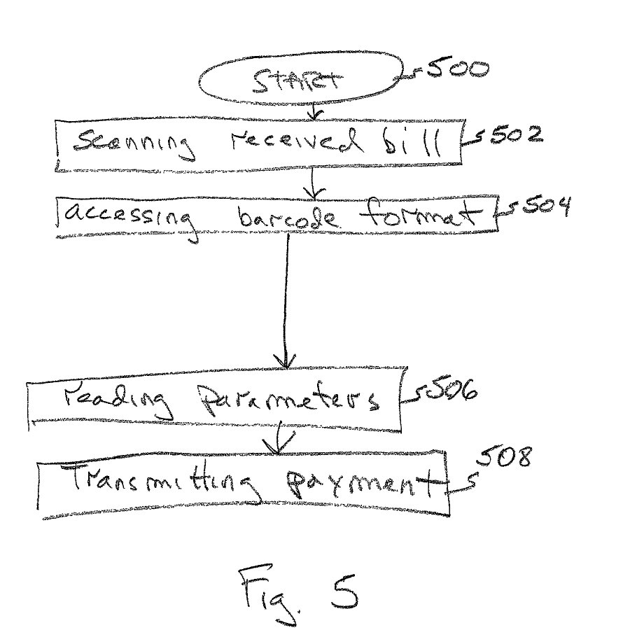

FIG. 5 is a flowchart illustrating an alternate aspect of the method of FIG. 4 for automatically paying bills. The method starts at Step 500. Step 502 scans a received bill with billing information encoded as barcode. Step 504 accesses billing information barcode format. Step 506 decodes parameters from the received bill barcode. Step 508 transmits a payment in response to the parameters.

A system and method have been provided for automating paying a scanned bill. A few examples have been given of how such a system can be used and enabled. However, other variations and embodiments of the invention will occur to those skilled in the art.

We claim:

1. A method for automatically paying bills, the method comprising:
scanning a received bill;
accessing a standard template library (STL);
matching the received bill to a bill template from the STL;
using the bill template to identify data areas;
reading parameters from data areas on the received bill; and,
transmitting a payment in response to the parameters.

2. The method of claim 1 wherein reading parameters from data areas on the received bill includes reading parameters selected from the group including account number, the service provider address, the due date, and the amount owed.

3. The method of claim 2 further comprising:
establishing an accessible on-line checking account; and,
wherein transmitting a payment includes:
electronically debiting the checking account; and,
submitting the payment through an action selected from the group including electronically submitting the amount due to the service provider drawn on the checking account and generating a check to the service provider drawn on the checking account.

4. The method of claim 2 wherein transmitting a payment includes printing a check with populated fields selected from the group including payee's name, amount, account number, and signature.

5. The method of claim 2 further comprising:
creating a new template;
identifying data areas on the new template; and,
adding the new template to the standard template library.

6. The method of claim 2 further comprising:
accessing an on-line server master template library; and,
downloading templates into a local database standard template library.

7. The method of claim 6 wherein accessing an on-line server master template library includes accessing the master template library in response to an action selected from the group included automatic periodic updating and a user-initiated requests.

8. The method of claim 6 wherein accessing an on-line server master template library includes accessing a master template library with templates in a first plurality of languages; and,
wherein downloading templates into a local database standard template library includes selecting a language.

9. The method of claim 2 wherein reading parameters from data areas on the received bill includes using an optical character recognition (OCR) algorithm to read information in the identified data areas.

10. The method of claim 9 further comprising:
selecting an operating mode from the group including automatic and semi-automatic;
wherein transmitting a payment in response to the parameters includes:
in response to selecting the semi-automatic operating mode, supplying user prompts selected from the group including payment date and payment amount, and paying the bill in response to the selected user prompts; and,
in response to selecting the automatic mode, automatically paying the bill.

11. The method of claim 2 further comprising:
archiving the received bill and transmitted payments.

12. The method of claim 1 further comprising:
accessing an accounting application; and,
in response to accessing the accounting application, performing an action selected from the group including making a record of the received bill in the accounting application, automatically transmitting a payment, accessing an on-line account, and making a record of the transmitted payment in the accounting application.

13. A method for automatically paying bills, the method comprising:
scanning a received bill with billing information encoded as barcode;
accessing billing information barcode format;
decoding parameters from the received bill barcode; and,
transmitting a payment in response to the parameters.

14. An automatically bill paying system, the system comprising:
a scanner having an input to accept a received bill and an output to supply a scanned readout of the bill;
a standard template library (STL) including a plurality of bill templates;
a bookkeeper having a port connected to the scanner output to received scanned bills and a port connected to the standard template library to receive bill templates, the bookkeeper matching the received bill to a bill template from the STL, using the bill template to identify data areas, and reading parameters from data areas on the received bill; and,
a treasurer having a input to receive parameters from the bookkeeper and a output to supply a payment in response to the parameters.

15. The system of claim 14 wherein the bookkeeper reads parameters from data areas on the received bill selected from the group including account number, the service provider address, the due date, and the amount owed.

16. The system of claim 15 further comprising:
an accessible on-line checking account; and,
wherein the treasurer communicates with the on-line checking account to electronically debit the checking account in response to an action selected from the group including electronically submitting the amount due to the service provider drawn on the checking account and generating a check to the service provider drawn on the checking account.

17. The system of claim 15 wherein the treasurer prints a check with populated fields selected from the group including payee's name, amount, account number, and signature.

18. The system of claim 15 wherein the standard template library has an input to accept a new template, the standard template library identifying data areas on the new template and adding the new template to the standard template library.

19. The system of claim 15 further comprising:
an on-line server master template library; and,
wherein the standard template library has an input to accept downloaded templates from the master template library.

20. The system of claim 19 wherein the standard template library accesses the on-line server master template library in response to an action selected from the group included automatic periodic updates and a user-initiated requests.

21. The system of claim 19 wherein master template library includes templates in a first plurality of languages; and,
wherein the standard template library downloads templates in response to selecting a language.

22. The system of claim 15 wherein the bookkeeper includes an optical character recognition (OCR) algorithm to read information in the identified data areas.

23. The system of claim 22 further comprising:
a user interface for selecting an operating mode from the group including automatic and semi-automatic;
wherein the user interface supplies user prompts selected from the group including payment date and payment amount, in response to the semi-automatic operating mode being selected; and,
wherein the treasurer pays the bill in response to the selected user prompts when the semi-automatic mode is selected and automatically pays the bill in response to the automatic mode being selected.

24. The system of claim 15 further comprising:
an archive having an input connected to the scanner output for storing received bills and to the treasurer output for storing transmitted payments.

25. The system of claim 14 further comprising:
an accounting application having a port connected to the bookkeeper and the treasurer to perform actions selected from the group including making a record of the received bill in the accounting application, ordering the treasurer to automatically transmit a payment, ordering the treasurer to access an on-line account, and making a record of the transmitted payment in the accounting application.

26. A system for automatically paying bills, the system comprising:
a scanner having an input to accept a received bill with barcode information and an output to supply a scanned readout of the bill barcode;
a bookkeeper having a port connected to the scanner output to received scanned bills and a port connected to receive the barcode format, the bookkeeper reading parameters from the barcode on the received bill; and,
a treasurer having a input to receive parameters from the bookkeeper and a output to supply a payment in response to the parameters.
